(19) United States
(12) Patent Application Publication
(10) Pub. No.: US 2026/0274115 A1
(43) Pub. Date: Sep. 17, 2026

(54) FUEL CELL CONTROL SYSTEM

(71) Applicants: KABUSHIKI KAISHA TOYOTA CHUO KENKYUSHO, Nagakute-shi, Aichi-ken (JP); DENSO CORPORATION, Kariya-city, Aichi-pref. (JP)

(72) Inventors: Takao WATANABE, Nagakute-shi (JP); Norihiro FUKAYA, Nagakute-shi (JP); Naoyuki YAMADA, Kariya-city (JP); Naoya WAKAYAMA, Kariya-city (JP); Kohei KAWABATA, Kariya-city (JP)

(73) Assignees: KABUSHIKI KAISHA TOYOTA CHUO KENKYUSHO, Nagakute-shi, Aichi-ken (JP); DENSO CORPORATION, Kariya-city, Aichi-pref. (JP)

(21) Appl. No.: 19/166,397

(22) PCT Filed: Dec. 12, 2023
(86) PCT No.: PCT/JP2023/044500

§ 371 Date: Sep. 17, 2025

(30) Foreign Application Priority Data
Mar. 24, 2023 (JP) 2023-048737

(51) Int. Cl. B60L 58/30; H01M 8/04298; H01M 8/04537; H01M 8/04858

(52) U.S. Cl. CPC B60L 58/30; H01M 8/04305; H01M 8/04544; H01M 8/04604; H01M 8/04925; B60L 2260/52

(57) ABSTRACT

A fuel cell control system that improves the durability of a fuel cell by adaptation to the actual way the fuel cell is used. This fuel cell control system includes: a PM control model that generates an FC power generation command value for causing a fuel cell to output the power necessary for traveling a target endurance distance; a correction unit that, if there is more than a prescribed divergence between an actually measured voltage value of the fuel cell and an estimated voltage value obtained using an IV performance model, corrects parameters that form the IV performance model; an endurance distance prediction model that calculates a predicted endurance distance of a vehicle using the IV performance model with the corrected parameters; and a PM control parameter correction unit that, if the predicted endurance distance does not reach the target endurance distance, corrects parameters of the PM control model.

### TECHNICAL FIELD

The present invention relates to a fuel cell control system and, in particular, to a fuel cell of enhanced durability.

### BACKGROUND

Fuel cells are incorporated in various types of means of transportation and machinery such as vehicles, ships, construction machinery, and agricultural machinery (hereinafter collectively referred to as “applications”) and serve as motive power sources. Even when fuel cells are used in the same application, the required durability varies depending on the purpose of use. For example, when the application is a vehicle, the durability required of fuel cells varies depending on, for example, whether the vehicle is driven relatively often on ordinary roads or whether the vehicle is driven relatively often on expressways. Therefore, a fuel cell controlling system determines beforehand, for example, an endurance driving range which indicates the distance within which the fuel cell enables the vehicle to travel, thereby controlling the output of the fuel cell so that the endurance driving range is greater than or equal to the requirement for the endurance target or, in other words, the target driving distance.

### CITATION LIST

### Patent Literature

Patent Document 1: JP 5106867 B

### SUMMARY

### Technical Problem

While the durability of the same fuel cell may vary in accordance with the manner in which it is used, it is desired to have the ability to control the power generation of the fuel cell so as to achieve at least the target durability.

The present invention is directed toward improving the durability of a fuel cell by adapting to the manner in which the fuel cell is actually used.

### Solution to Problem

According to an aspect of the present invention, there is provided a fuel cell control system comprising control model execution means for executing a control model for controlling power generation of a fuel cell in accordance with schedule information which indicates use of drive means that is driven using the fuel cell as motive power; prediction model execution means for executing a prediction model for predicting, from a power generation status of the fuel cell, electric power that can be generated by the fuel cell as a predicted power generation capacity; prediction model correction means for determining that an error occurs in the predicted power generation capacity predicted using the prediction model when a gap greater than or equal to a predetermined gap is observed between an actual power generation status of the fuel cell and a power generation status of the fuel cell estimated with reference to the schedule information, and for correcting a parameter used in the prediction model so as to remove the error in the predicted power generation capacity; and control model correction means for correcting a parameter in the control model to enable the fuel cell to achieve a target power generation capacity of the fuel cell obtained from the schedule information when a predicted power generation capacity predicted using the prediction model for which parameter correction has been performed is less than the target power generation capacity.

The drive means may be a movable traveling means, the control model may control the power generation of the fuel cell so that a target distance obtained from schedule information can be traveled, the prediction model may predict a driving range of the traveling means as the predicted power generation capacity, and when the driving range of the traveling means predicted by the prediction model is less than the target distance, the control model correction means may correct the parameter used by the control model to enable the fuel cell to achieve the target power generation capacity so that the traveling means can travel the target distance.

The control model correction means may perform at least one of either correction toward a decrease in a parameter value that defines a maximum value in the power generation of the fuel cell or correction toward an increase in a parameter value that defines a minimum value in the power generation of the fuel cell.

The control model correction means may correct the parameter used by the control model so that the drive means is driven at minimum total cost.

When a gap greater than or equal to a predetermined gap is observed between a voltage measurement value of the fuel cell which indicates the actual power generation status of the fuel cell and a voltage estimated value of the fuel cell which indicates the power generation status of the fuel cell estimated with reference to the schedule information, the prediction model correction means may correct the parameter used by the prediction model.

The parameter used by the prediction model may be a velocity constant.

### Advantageous Effects of Invention

An invention as defined in claim 1 enables improved durability of a fuel cell by adapting to the manner in which the fuel cell is actually used.

Inventions as defined in claims 2 and 3 enable control for achieving a target driving distance more reliably.

An invention as defined in claim 4 enables control of the output of the fuel cell so that the drive means is driven at minimum total cost.

Inventions as defined in claims 5 and 6 enable an improved prediction accuracy of the prediction model.

### BRIEF DESCRIPTION OF DRAWINGS

FIG. 1 is an overall configuration diagram illustrating a fuel cell control system according to an embodiment of the present invention.

FIG. 2 is a flowchart of a fuel cell control process according to the embodiment.

FIG. 3 is a block configuration diagram illustrating a PM control model according to the embodiment.

FIG. 4 is a graph diagram schematically illustrating a relationship between current and voltage output from the fuel cell according to the embodiment.

FIG. 5 lists descriptions of symbols used in computational expressions for calculating a voltage estimated value in the embodiment.

FIG. 6(a) schematically illustrates a relationship between current and voltage, and (b) schematically illustrates a relationship between current and power for illustration of an output voltage from the fuel cell in response to a decrease in an FC electric power command maximum value.

FIG. 7(a) schematically illustrates a relationship between current and voltage, and (b) schematically illustrates a relationship between current and power for illustration of an output voltage from the fuel cell in response to an increase in an FC electric power command minimum value.

FIG. 8 illustrates a range of voltage fluctuation in the fuel cell in the embodiment.

### DESCRIPTION OF EMBODIMENTS

Preferred embodiments of the present invention will be described below with reference to the drawings.

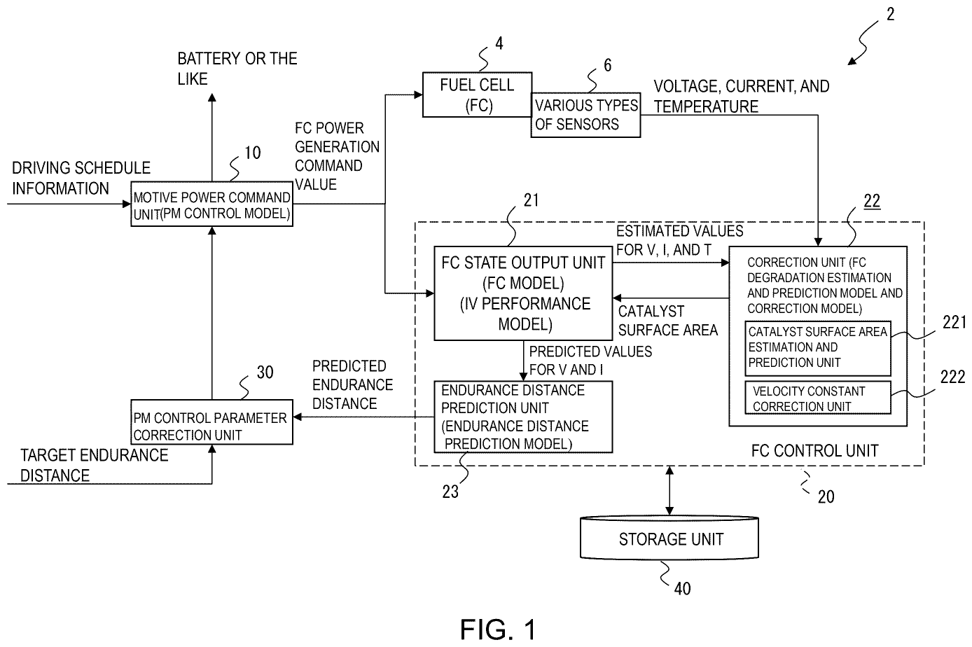

FIG. 1 is an overall configuration diagram illustrating an embodiment of a fuel cell control system according to the present invention. For description of this embodiment, a vehicle, which is one of the applications, is taken as an example of the drive means powered by a fuel cell (FC). It should be noted that components that are not used in the description of the embodiment are not illustrated in the diagram.

FIG. 1 illustrates a fuel cell 4 and various types of sensors 6, and a motive power command unit 10, an FC control unit 20, a PM (Power Management) control parameter correction unit 30, and a storage unit 40, all of which are included in a fuel cell control system 2. The fuel cell 4 is a device that generates electricity through a chemical reaction of hydrogen and oxygen. The various types of sensors 6 serve as sensor means for actually measuring voltage, current, and internal temperature of the fuel cell 4 as data that may identify the power generation status of the fuel cell 4. As such, the term “various types of” collectively refers to a voltage sensor, a current sensor, and a temperature sensor.

The fuel cell control system 2 of the illustrated embodiment can be implemented by a computer and includes, for example, a processor, ROM, RAM, storage means, and communication means. Various types of functions described below are implemented through cooperation of a computer and a program executable on a CPU installed on the computer. The storage unit 40 is implemented by storage means. Alternatively, the storage unit 40 may use RAM or external storage means via a network. When, as in the illustrated embodiment, the fuel cell 4 is mounted on a vehicle, the computer may be implemented by an ECU (Electronic Control Unit). The program can be provided not only by communication means but also in the form of being stored on a computer-readable storage medium.

The term “durability” is defined as, for example, the quality of being long-lasting and enduring. In the illustrated embodiment, as a vehicle serving as the movable traveling means is given as an example of the drive means, the distance which it has traveled or, in other words, the driving distance is used as an index which indicates the durability of the fuel cell 4. Therefore, in the illustrated embodiment, the ability to allow the vehicle to travel as long a distance as possible is equivalent to the ability to improve the durability of the fuel cell 4. It should be noted that the ability to allow the vehicle to travel as long a distance as possible includes not only the ability to allow the vehicle to complete traveling a target driving distance or a target driving time but also the ability to allow the vehicle to travel a driving distance or a driving time of a predetermined value or longer after completion of the traveling of the target driving distance or the target driving time. In addition to the driving distance and the driving time, examples of indices which indicate the durability of a vehicle may include, for example, hill-climbing performance, acceleration performance, maximum vehicle speed, and other vehicle driving capabilities, as well as fuel efficiency.

In the illustrated embodiment, the vehicle may incorporate therein, for example, a battery and a secondary battery in addition to the fuel cell 4 as motive power sources. The vehicle may have plans set beforehand as to, for example, the purpose of use and the driving pattern in which it is used for that purpose, the driving distance in kilometers per year, and the estimated number of years for which the vehicle will be used. The driving pattern refers to, for example, a model case of the manner in which the vehicle is used, such as use of the vehicle only on ordinary roads and tendencies to basically choose expressways for long-distance transportation and to basically not use the vehicle on holidays. In the illustrated embodiment, for example, schedules or plans; that is, schedule information indicating the manner in which the vehicle will be used, are set beforehand as “driving schedule information”. It should be understood that the driving schedule information is set while assuming the actual driving capabilities of the vehicle.

While, in the illustrated embodiment, the vehicle may include multiple types of motive power sources as described above, for ease of description attention is focused only on the fuel cell 4, and the following description assumes that the driving distance which indicates the durability required based on the driving schedule information is traveled using the fuel cell 4 alone. This driving distance (hereinafter referred to as “target endurance distance”), which is a driving distance obtained by analyzing the driving schedule information, is based on the power generation capacity of the fuel cell 4 and therefore can be considered to be an index that indicates a target power generation capacity of the fuel cell 4. It should be understood that the target power generation capacity of the fuel cell 4 is set within the power generation capacity physically achievable by the fuel cell 4.

Returning to FIG. 1, components of the fuel cell control system 2 will be described below.

The motive power command unit 10 calculates, from the driving schedule information, when and how much motive power the vehicle will require, and then distributes the results of this calculation or, in other words, predicted motive power required for the driving schedule of the vehicle, to the vehicle-mounted motive power sources. In the illustrated embodiment, of the motive power that the motive power command unit 10 distributes to the motive power sources, the motive power distributed to the fuel cell 4 or, in other words, the motive power which indicates how much power the fuel cell 4 is caused to generate, is referred to as “FC power generation command value”. The FC power generation command value is expressed in the form of electric power (W). The motive power command unit 10 executes a PM control model for controlling the power generation of the fuel cell 4 in accordance with the driving schedule information, thereby determining electric power that the fuel cell 4 is caused to output.

It should be noted that the motive power command unit 10 issues a command so as to achieve, together with the motive power sources other than the fuel cell 4, the driving distance required based on the driving schedule information, but in the description of the illustrated embodiment, as described above, attention is focused only on the fuel cell 4. Therefore, the motive power command unit 10 controls the power generation of the fuel cell 4 so that a target endurance distance obtained from the driving schedule information can be traveled.

The FC control unit 20 controls the output of the fuel cell 4 in accordance with the FC power generation command value. For example, the FC control unit 20 controls the fuel cell 4 so that the vehicle can travel the target driving distance or a longer distance. The FC control unit 20 predicts a maximum driving distance (hereinafter referred to as “predicted endurance distance”) that the fuel cell 4 can endure traveling when the fuel cell 4 outputs the FC power generation command value or, in other words, required electric power. The predicted endurance distance predicted at the time when the vehicle begins traveling is a distance equivalent to the target endurance distance. Therefore, when the vehicle completes traveling as set in the driving schedule information, the predicted endurance distance and the target endurance distance, in theory, are of the same value.

The FC control unit 20 includes an FC state output unit 21, a correction unit 22, and an endurance distance prediction unit 23.

The FC state output unit 21 executes an FC model for outputting voltage and current as data indicating the power generation status of the fuel cell 4 according to an IV performance model. Specifically, the FC state output unit 21 determines voltage and current applied at the time when the FC power generation command value (required electric power) is output. The FC state output unit 21 may estimate and output the temperature of the fuel cell 4.

The correction unit 22 obtains the actual power generation status of the fuel cell 4 or, in other words, the voltage and current output from the fuel cell 4 and the temperature of the fuel cell 4, which are actually measured by the various types of sensors 6. The correction unit 22 also obtains the power generation status of the fuel cell 4 estimated by the FC state output unit 21 or, in other words, the voltage and current output from the fuel cell 4 and the temperature of the fuel cell 4. A deviation occurring between the voltage and current of the fuel cell 4 estimated by the FC state output unit 21 and the voltage and current actually measured by the various types of sensors 6 may cause a deviation in prediction of the driving distance by the endurance distance prediction unit 23, which will be described below. Therefore, when a gap greater than or equal to a predetermined gap is observed between the actual power generation status of the fuel cell 4 and the power generation status of the fuel cell 4 estimated by the FC state output unit 21, the correction unit 22 determines that an error occurs in the predicted endurance distance predicted using a prediction model, and then corrects a parameter used in the prediction model, or specifically a parameter referred to for generation of the IV performance model, so as to remove the error in the predicted endurance distance.

In the correction unit 22, a catalyst surface area estimation and prediction unit 221 executes an FC degradation estimation and prediction model, thereby predicting the surface area of a catalyst contained in the fuel cell 4. A velocity constant correction unit 222 executes a correction model, thereby correcting a velocity constant used in the calculation of the catalyst surface area. The velocity constant is a constant representing the velocity at which the catalyst undergoes elution or precipitation. Although, in the illustrated embodiment, the velocity constant is reassessed and corrected for improved calculation accuracy of the predicted endurance distance, not only the velocity constant but also another parameter or multiple parameters may be corrected.

The endurance distance prediction unit 23 executes an endurance distance prediction model for predicting the driving distance (in other words, predicted endurance distance) of the vehicle from a predicted value of the power generation status (in other words, voltage and current) of the fuel cell 4 obtained from the IV performance model for which the parameter has been changed by the correction unit 22, thereby calculating the predicted endurance distance. As the vehicle travels using electric power output from the fuel cell 4, the predicted endurance distance is calculated as generatable electric power (predicted power generation capacity) that can be generated by the fuel cell 4.

When the predicted endurance distance obtained by the endurance distance prediction unit 23 does not reach the target endurance distance obtained from the driving schedule information, the PM control parameter correction unit 30 corrects the parameter in the PM control model used by the motive power command unit 10 so that the fuel cell 4 can achieve the target power generation capacity to allow the vehicle to travel the target endurance distance.

The storage unit 40 stores therein, for example, an actual measurement value such as voltage referred to in the process in which the FC power generation command value is input to the FC control unit 20 to determine a predicted endurance distance, an estimated value, or a predicted endurance distance. These data items are, as appropriate, referred to at the time of estimation of, for example, the present voltage.

The fuel cell control system 2 of the illustrated embodiment is configured as described above. It should be noted that FIG. 1 also indicates model names associated with the respective components, such as “PM control model” associated with the motive power command unit 10, “FC model” and “IV performance model” associated with the FC state output unit 21, “FC degradation estimation and prediction model” and “correction model” (hereinafter collectively referred to as “FC degradation estimation model”) associated with the correction unit 22, and “endurance distance prediction model” associated with the endurance distance prediction unit 23. The following description may use model names rather than the functional block names representing the respective components.

Even if, for example, the driving pattern is planned and set at the beginning of the driving, the actual driving pattern of the vehicle does not necessarily proceed as planned. In consideration of unexpected factors such as occurrence of an accident or the influence of the weather, it appears that the vehicle would typically rather travel in a manner different from that planned. A driving pattern different from that planned will also change the manner in which the fuel cell 4 is used. Further, the FC degradation estimation model and the endurance distance prediction model used for predicting the endurance distance also suffer from uncertainty. While a difference in the estimated value may occur depending on, for example, the difference in materials used in the fuel cell 4 and the environment in which it is operated, these factors are uncertain and changeable before the use of the fuel cell 4. As described above, for the two reasons attributable to the manner in which the vehicle is actually used and the uncertainties in the models, a gap may occur between the endurance distance assumed beforehand by calculation and the actual endurance distance.

With this being the situation, in the illustrated embodiment, to achieve the endurance target distance, the parameters of the models in the FC control unit 20 are corrected so as to reduce the gap between the actual endurance distance and the endurance distance predicted by calculation or, in other words, for improved calculation accuracy of the predicted endurance distance. After the parameter correction, when the predicted endurance distance is less than the target endurance distance, the PM control parameters are corrected so that the predicted endurance distance can be not less than the target endurance distance and, if possible, can be greater than the target endurance distance.

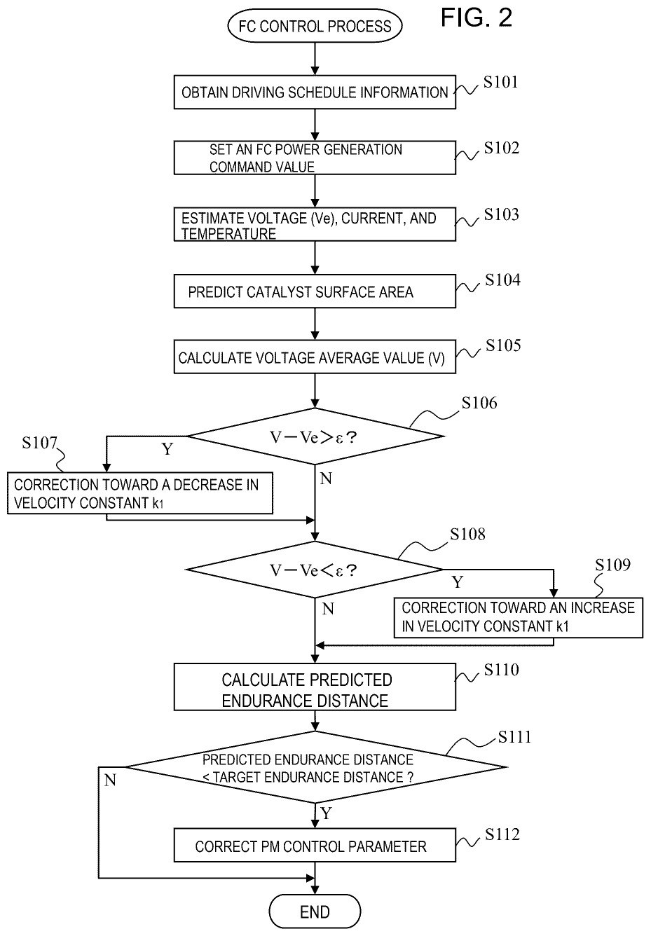

Referring now to the flowchart of FIG. 2, an operation according to the illustrated embodiment will be described below.

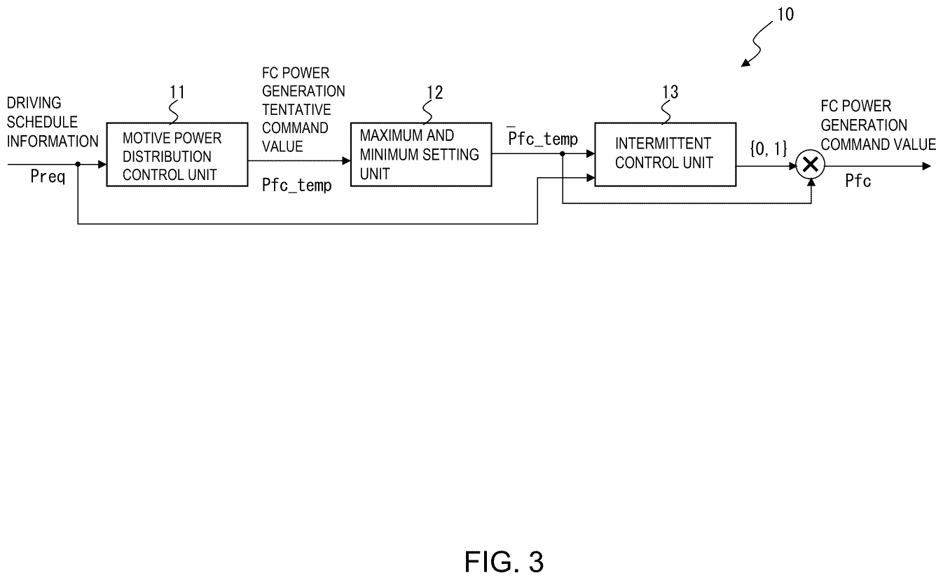

Assume that driving schedule information is generated by setting, for example, an assumed driving pattern beforehand as described above. A PM control model 10 obtains the driving schedule information (step 101) and then sets an FC power generation command value (step 102). Referring to FIG. 3, the setting process of the FC power generation command value in the PM control model 10 will be described below.

FIG. 3 is a block configuration diagram illustrating the PM control model 10 according to the illustrated embodiment. The PM control model 10 includes a motive power distribution control unit 11, a maximum and minimum setting unit 12, and an intermittent control unit 13. Upon input of the driving schedule information to the PM control model 10, the motive power distribution control unit 11 calculates from the driving schedule information how much motive power (power) the vehicle will require or, in other words, the total amount of power, and then distributes the total amount of power to the fuel cell 4 and other motive power sources such as a vehicle-mounted battery. Of the power that is to be distributed, FIG. 3 illustrates electric power that is to be distributed to the fuel cell 4 as an FC power generation tentative command value. It should be understood that, if, from the driving pattern, a relatively large amount of power is needed, the total amount of power required of the individual motive power sources will be relatively increased, and if only a relatively small amount of power is needed, the total amount of power required of the individual motive power sources will be relatively reduced. However, the power that is to be distributed to each of the motive power sources may not necessarily be proportional to the total amount of power. The PM control model 10 is a model that performs such power distribution.

For the electric power that is to be distributed to the fuel cell 4, a maximum value and a minimum value are set beforehand. The maximum and minimum setting unit 12 corrects the FC power generation tentative command value as appropriate to assume a value between the maximum value and the minimum value. The intermittent control unit 13 refers to the FC power generation tentative command value corrected as appropriate and the driving schedule information to set intermittent control of the fuel cell 4. The “intermittent control” represents control to set whether the fuel cell 4 is operated to output a voltage (flag=1) or whether the fuel cell 4 is not operated (flag=0).

As described above, the PM control model 10 calculates electric power that the fuel cell 4 is caused to output, as the FC power generation command value. The fuel cell 4 outputs electric power in accordance with the FC power generation command value transmitted from the PM control model 10. It should be noted that the distribution itself of motive power performed by the PM control model 10 may be performed in a conventional manner.

Subsequently, an FC model 21 estimates the voltage and current that the fuel cell 4 outputs using the IV performance model on the basis of the FC power generation command value, and the internal temperature of the fuel cell 4 (step 103). It should be noted that, as the voltage, current, and temperature, the FC model 21 may use actual measurement values measured by the various types of sensors 6 but in the illustrated embodiment, estimation is performed according to predetermined calculation methods.

In the illustrated embodiment, voltage is either estimated according to predetermined calculation methods as described above or predicted as will be described below. In the illustrated embodiment, a present voltage that is obtained by calculation with reference to past history data such as an actual measurement value is referred to as an “estimated value” of voltage. A future voltage that is obtained by calculation from past history data such as an actual measurement value or the estimated value is referred to as a “predicted value” of voltage. It should be noted that the “actual measurement value” is a value that is obtained by actual measurement using a sensor 6 when the vehicle is actually driven.

Therefore, the “voltage estimation” represents determination of a present voltage by calculation. On the other hand, the “voltage prediction” represents determination of a future voltage by calculation. Identification of the FC power generation command value representing the manner in which the fuel cell 4 is used until now enables voltage estimation. Having the FC power generation command value assumed from now to the future enables voltage prediction. As such, voltage prediction requires assumption of the FC power generation command value. Therefore, the driving pattern of the vehicle should be planned to assume the FC power generation command value. As will be described below, an endurance distance prediction model 23 can predict an endurance distance only after the voltage prediction.

The estimated value and the predicted value of voltage are both calculated using computational expressions (1) to (4) below. Here, i₀ represents exchange current density. For voltage estimation and prediction, an exchange current density i₀ should be either estimated or predicted. As illustrated in FIG. 1, an FC power generation command value is determined from the driving schedule information, and the voltage and catalyst potential of the fuel cell 4 are determined from the FC power generation command value, thereby enabling determination of the potential of formula (4). From formula (4) to formula (2), i₀ can be calculated. Therefore, having the driving pattern of the vehicle assumed from the present to the future enables prediction of voltage, thereby enabling prediction of the endurance distance.

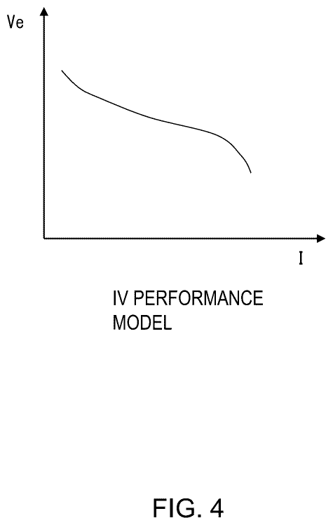

FIG. 4 is a graph diagram schematically illustrating the relationship between the current (I) and the voltage (V) output from the fuel cell 4, which is obtained from formula (1) that calculates a voltage estimated value Ve.

$$\begin{matrix}[ Equation 1 ] & \\ Ve = {V}_{OCV} - {R}_{Ω} \cdot I - b \cdot log ( \frac{I}{{i}_{0}} ) - b \cdot log ( \frac{{C}_{ref}}{{C}_{O 2} - {R}_{MT} \frac{I}{4 F}} ) & ( 1 )\end{matrix}$$

Here, I is current density and represents current-dependent IV characteristic. Also, i₀ is exchange current density and is represented by the following formula (2):

$$\begin{matrix}[ Equation 2 ] & \\ {i}_{0} ( t ) = {I}_{0} \cdot {θ}_{act} \cdot exp ( \frac{a}{T} ) \cdot {\sum }_{i}^{n} {r}_{{Pt}_{i}}^{2} ( t ) & ( 2 )\end{matrix}$$

As expressed by formula (2), the exchange current density i₀ changes depending on catalyst degradation in the fuel cell 4. The catalyst degradation proceeds as an increase in the radii of catalyst particles is caused by catalyst elution and precipitation and as the total surface area of the catalyst particles is decreased. A mathematical model of this process is the following formula (3) and represents the relationship between the reaction velocity of the catalyst elution and precipitation reaction and the change in the radii of catalyst particles over time.

$$\begin{matrix}[ Equation 3 ] & \\ \frac{d}{dt} {r}_{{Pt}_{i}} ( t ) = {k}_{Pt} \cdot {react}_{1 , i} ( t ) & ( 3 )\end{matrix}$$

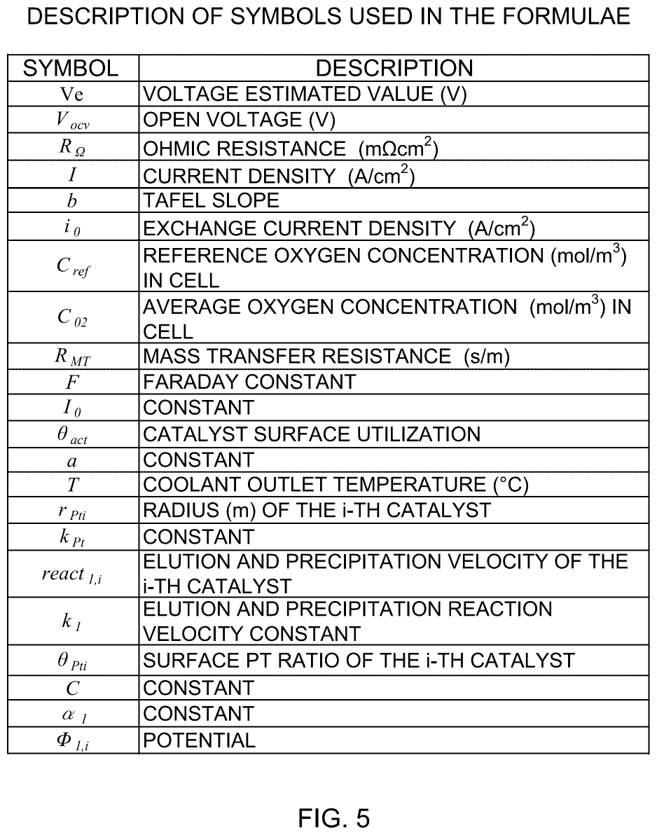

Here, the elution and precipitation velocity of an i-th catalyst is a function of the potential dependent on the catalyst potential as expressed by the following formula (4), where the coefficient is the elution and precipitation reaction velocity constant (“velocity constant” above) k₁ of the catalyst. It should be noted that descriptions of the symbols used in the formulae (1) to (4) above are given in FIG. 5.

$$\begin{matrix}[ Equation 4 ] & \\ {react}_{1 , i} ( t ) = {k}_{1} \cdot {θ}_{{Pt}_{i}} [ exp ( {α}_{1} {ϕ}_{1 , i} ( t ) ) - C exp ( - ( 1 - {α}_{1} ) {ϕ}_{1 , i} ( t ) ) ] & ( 4 )\end{matrix}$$

Subsequently, an FC degradation estimation model 22 predicts the surface area of the catalyst using the estimated values of voltage, current, and temperature (step 104). The degradation of the fuel cell 4 is in most cases equivalent to a decrease in the surface area of the catalyst. As the surface of the catalyst governs the power generation reaction, a decrease in surface area correspondingly worsens the power generation reaction. Therefore, the decrease in surface area of the catalyst directly leads to a voltage drop in the IV performance. As such, the FC degradation estimation model 22 predicts the surface area of the catalyst for use in calculation of the voltage and generates an IV performance model in which the predicted surface area of the catalyst is incorporated.

Subsequently, the FC degradation estimation model 22 corrects a parameter for generation of the IV performance model so as to reduce the gap between a voltage actual measurement value obtained during actual driving until the present time and a voltage estimated value estimated by calculation until the present time in a subsequent iterative process. The parameter correction is, in short, for reduction in the error in the voltage and, in turn, reduction in the error in the driving distance. In the illustrated embodiment, the velocity constant k₁ is given as an example of a parameter that is to be corrected.

The FC degradation estimation model 22 determines whether or not the velocity constant k₁ should be corrected and, if so, corrects the velocity constant k₁ (steps 106 to 109). More specifically, the average value V of the voltages measured within, for example, a few recent days is calculated as the past voltage at a certain current density during a predetermined period of time from the present time at which an actual measurement value of voltage is obtained. A predicted value Ve at the same current density at the present time calculated by the FC degradation estimation model 22 is calculated.

The FC degradation estimation model 22 compares the calculated voltage average value V and the voltage predicted value Ve, and if the difference between the voltage average value V and the voltage predicted value Ve is greater than a preset threshold value & (Y in step 106), the velocity constant k₁ is corrected to be reduced (step 107). Then, if the difference between the voltage predicted value Ve and the voltage average value V is less than the threshold value & (N in step 106 and Y in step 108), the velocity constant k₁ is corrected to be increased (step 109).

While the voltage predicted value Ve should ideally be equal to the voltage average value V, it can be assumed that the results of calculation of the average value may vary depending on, for example, the setting of the period of time that is referred to for calculation of the average value. Therefore, in the illustrated embodiment, the threshold value & is set in consideration of tolerance. The pitch by which the velocity constant k₁ is increased or decreased may be set as desired. For example, an increase amount and a decrease amount may be of the same value or may be of different values. Upon an increase or a decrease, the increase or decrease pitch does not have to be always the same and may be set as desired in accordance with, for example, the time of the year. It should be noted that, as which of the voltage measurement value and the voltage predicted value is greater or less than the other may be reversed when the velocity constant k₁ is increased or decreased by an overly large pitch, the increase or decrease pitch is set to avoid such reversal in consideration of the above.

After the parameters in the IV performance model are corrected as described above, the endurance distance prediction model 23 subsequently calculates a predicted endurance distance, thereby predicting the endurance distance (step 110). More specifically, while the endurance distance prediction model 23 calculates the predicted endurance distance using computational expressions similar to those used for calculating the voltage estimated value, the voltage predicted value is not necessarily the same value as the voltage estimated value as the IV performance model is updated by correcting the parameters as described above.

Subsequently, the PM control parameter correction unit 30 compares the predicted endurance distance obtained by the endurance distance prediction model 23 and the target endurance distance obtainable from the driving schedule information. If the predicted endurance distance is greater than or equal to the target endurance distance (N in step 111), the process ends as the target driving distance can be accomplished with the fuel cell 4 being maintained to output electric power according to the predicted power generation capacity. Although the process ends in the flowchart of FIG. 2, the process may include, for example, a further attempt to correct the parameters to further extend the predicted endurance distance.

On the other hand, if the predicted endurance distance is less than the target endurance distance (Y in step 111), the PM control parameter correction unit 30 determines that the target driving distance cannot be traveled even if the fuel cell 4 is maintained to output electric power according to the predicted power generation capacity or, in other words, even if power generation for traveling the predicted endurance distance is continued, thus correcting the parameters used by the PM control model 10 so that the predicted endurance distance is greater than or equal to the target endurance distance. In the following description of the illustrated embodiment, of the parameters used by the PM control model 10, for example, an FC electric power command maximum value Pfcₘₐₓ, which defines the maximum value in the power generation of the fuel cell 4, or an FC electric power command minimum value Pfcₘᵢₙ, which defines the minimum value in the power generation of the fuel cell 4, are to be corrected.

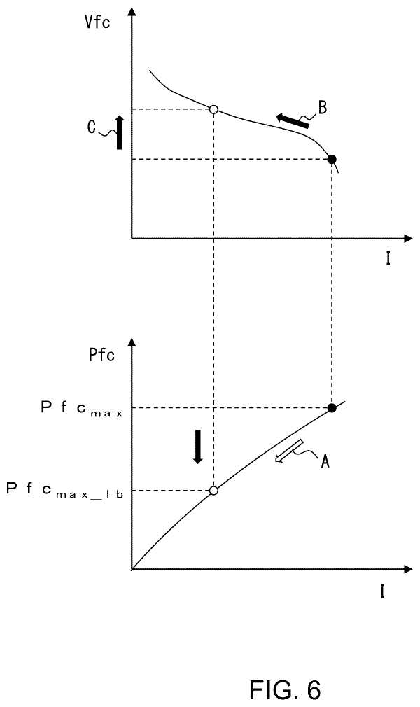

The lower limit of the adjustable range for the FC electric power command maximum value Pfcₘₐₓ is set to Pfc_{max_Ib}. When Pfcₘₐₓ−Pfc_{max_Ib}>0, the FC electric power command maximum value Pfcₘₐₓ is corrected to decrease or, in other words, to be closer to the lower limit value Pfc_{max_Ib}. FIG. 6 illustrates conceptual graphs of this process.

FIG. 6(a) represents the relationship between current and voltage or, in other words, the IV performance model, and FIG. 6(b) schematically illustrates the relationship between current and power. A correction toward a decreased FC electric power command maximum value Pfcₘₐₓ (arrow A) as illustrated in FIG. 6(b) shifts the operating range of the IV performance model toward a lower current (arrow B) and consequently increases the voltage minimum value (arrow C) as illustrated in FIG. 6(a). More specifically, as an upward correction of the minimum value of the voltage output from the fuel cell 4 restricts the output at a low voltage compared to before the correction of the parameter (FC electric power command maximum value Pfcₘₐₓ), the output tends to occur at a high voltage.

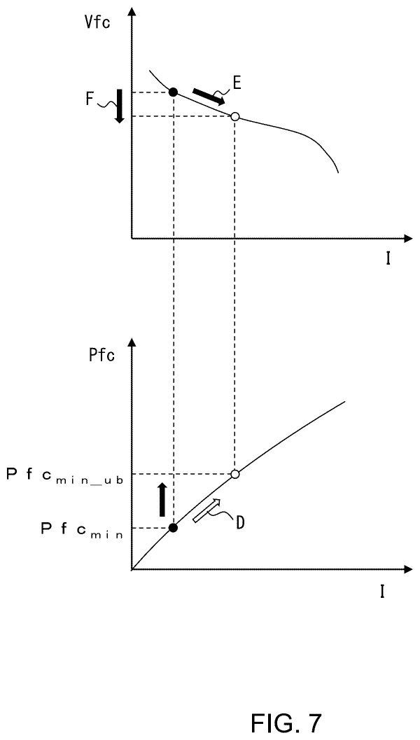

Also, with the upper limit of the adjustable range for the FC electric power command minimum value Pfcₘᵢₙ being set to Pfc_{min_ub}, when Pfc_{min_ub}−Pfcₘᵢₙ>0, the FC electric power command minimum value Pfcₘᵢₙ is corrected to increase or, in other words, to be closer to the upper limit value Pfc_{min_ub}. FIG. 7 illustrates conceptual graphs of this process.

FIG. 7(a) represents the relationship between current and voltage or, in other words, the IV performance model, and FIG. 7(b) schematically illustrates the relationship between current and power. A correction toward an increased FC electric power command minimum value Pfcₘᵢₙ (arrow D) as illustrated in FIG. 7(b) shifts the operating range of the IV performance model toward a higher current (arrow E) and consequently decreases the voltage maximum value (arrow F) as illustrated in FIG. 7(a). More specifically, as a downward correction of the maximum value of the voltage output from the fuel cell 4 restricts the output at a high voltage compared to before the correction of the parameter (FC electric power command minimum value Pfcₘᵢₙ), the output tends to occur at a low voltage.

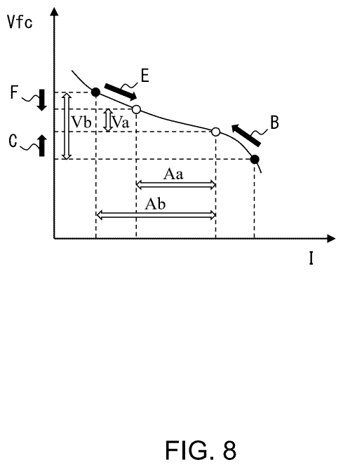

FIG. 8 illustrates the results of the above-described correction of the parameters or specifically a combination of FIGS. 6 and 7. FIG. 8 illustrates, for the voltage, an operating range Vb for which the parameters have yet to be corrected and an operating range Va for which the parameters have been corrected, and for the current, an operating range Ab for which the parameters have yet to be corrected and an operating range Aa for which the parameters have been corrected. As illustrated in FIG. 8, the operating ranges in the IV diagram of the IV performance model are narrowed for both current and voltage. This limits the range of voltage fluctuation which causes the acceleration of catalyst degradation due to elution and precipitation. The range of voltage fluctuation becomes narrower, thereby retarding degradation of the catalyst. A drop in the maximum current lowers the maximum temperature of the fuel cell 4, consequently retarding degradation of the catalyst. Thus, the above-described correction of the parameters in the PM control model 10 may increase the endurance distance as the reduction in IV performance is retarded.

It should be noted that, as described above, in the illustrated embodiment, the range of voltage or current fluctuation is limited by narrowing the operating ranges in the IV diagram of the IV performance model. To that end, both the FC electric power command maximum value Pfcₘₐₓ and minimum value Pfcₘᵢₙ are to be corrected, but at least one of these may be the target to be corrected. Another parameter that is capable of limiting the range of voltage or current fluctuation, such as an FC voltage maximum value Vfc^{max} or an FC voltage minimum value Vfcₘᵢₙ, may also be the target to be corrected.

The control process of the fuel cell 4 according to the illustrated embodiment is performed in the manner described above. In summary, the above-described control process proceeds as follows. As a first step, the target driving distance (target endurance distance) that is set with reference to the driving schedule information including an assumed driving pattern at the time of starting of the driving is defined as an initial setting. After that, an initial setting for the parameters of the IV performance model is defined so as to allow the vehicle to travel the target endurance distance. The fuel cell 4 then outputs electric power in accordance with the projected FC power generation command value. As the driving distance of the vehicle depends on the output voltage from the fuel cell 4, during the vehicle driving process, the degree of accuracy in a predicted driving distance (predicted endurance distance) can be determined based on the amount of gap between an actual measurement value of voltage in the fuel cell 4 and an estimated value of voltage estimated from the driving schedule information. Therefore, when a gap greater than or equal to a predetermined gap is observed between the actual measurement value and the estimated value, the parameters of the IV performance model are corrected to improve the prediction accuracy of the predicted endurance distance. Note that, when the predicted endurance distance obtained using the corrected IV performance model is less than the target endurance distance, the parameters in the PM control model 30 are further corrected so that the predicted endurance distance is greater than or equal to the target endurance distance.

While the control process of the fuel cell 4 according to the illustrated embodiment corrects the parameters as appropriate in accordance with the actual use of the fuel cell 4, the control process may be performed iteratively with predetermined timing after the use of the fuel cell 4 is started. For example, the control process may be performed upon turning points between seasons where there is a change in internal temperature of the fuel cell 4, or specifically at intervals such as once every three months, or the predicted endurance distance may be reassessed on a daily basis. It should be understood that the present invention is not limited to this example, but with desired timing in accordance with the manner in which the fuel cell 4 is used, the control process may be performed automatically at constant intervals or may be performed in accordance with manual instructions.

It should be noted that in the illustrated embodiment, the output of the fuel cell 4 is controlled with attention being focused on the durability of the fuel cell 4. Specifically, the output of the fuel cell 4 is controlled so that the predicted endurance distance is equal to or greater than the target endurance distance if possible. However, consideration may be given not only to durability but also to fuel cost required until the vehicle completes the traveling of, for example, the target endurance distance or to the total fuel expense and maintenance costs including costs for replacing parts. More specifically, the PM control parameter correction unit 30 may correct the parameters used by the PM control model 10 so that the vehicle is driven at minimum total cost while assuming that the vehicle can travel the target endurance distance. This requires information for calculating the total fuel expense such as the total amount of fuel needed to complete the traveling of the target endurance distance and the price of fuel per liter. Also, information for calculating maintenance costs such as when parts that require replacement are to be replaced, the prices of the parts, and the work charges is required. To that end, the fuel cell control system should have means for storing such information or communication means for externally obtaining such information via a network.

In the description of the illustrated embodiment, as a vehicle serving as the movable traveling means is given as an example of the drive means, the driving distance is used as an index which indicates the durability of the fuel cell 4 or, in other words, as an objective index that can take numerical form in accordance with the power generation capacity of the fuel cell 4. However, an index other than the driving distance may be used for the power generation capacity of the fuel cell 4 in accordance with the type of the drive means or the purpose of use. For example, an index which indicates the power generation capacity of the fuel cell 4 may be determined in accordance with the characteristics of the drive means such as the drive time of the drive means or the weight load of an object handled by the drive means.

### [Configurations of the Invention]

### Configuration 1:

A fuel cell control system comprising:
control model execution means for executing a control model for controlling power generation of a fuel cell in accordance with schedule information which indicates use of drive means that is driven using the fuel cell as motive power;
prediction model execution means for executing a prediction model for predicting, from a power generation status of the fuel cell, electric power that can be generated by the fuel cell as a predicted power generation capacity;
prediction model correction means for determining that an error occurs in the predicted power generation capacity predicted using the prediction model when a gap greater than or equal to a predetermined gap is observed between an actual power generation status of the fuel cell and a power generation status of the fuel cell estimated with reference to the schedule information, and for correcting a parameter used in the prediction model so as to remove the error in the predicted power generation capacity; and
control model correction means for correcting a parameter in the control model to enable the fuel cell to achieve a target power generation capacity of the fuel cell obtained from the schedule information when a predicted power generation capacity predicted using the prediction model for which parameter correction has been performed is less than the target power generation capacity.

### Configuration 2:

The fuel cell control system according to Configuration 1, wherein
the drive means is a movable traveling means,
the control model controls the power generation of the fuel cell so that a target distance obtained from the schedule information can be traveled,
the prediction model predicts a driving range of the traveling means as the predicted power generation capacity, and
when the driving range of the traveling means predicted by the prediction model is less than the target distance, the control model correction means corrects the parameter used by the control model to enable the fuel cell to achieve the target power generation capacity so that the traveling means can travel the target distance.

### Configuration 3:

The fuel cell control system according to Configuration 1 or 2, wherein the control model correction means performs at least one of either correction toward a decrease in a parameter value that defines a maximum value in the power generation of the fuel cell or correction toward an increase in a parameter value that defines a minimum value in the power generation of the fuel cell.

### Configuration 4:

The fuel cell control system according to any one of Configurations 1 to 3, wherein the control model correction means corrects the parameter used by the control model so that the drive means is driven at minimum total cost.

### Configuration 5:

The fuel cell control system according to any one of Configurations 1 to 4, wherein, when a gap greater than or equal to a predetermined gap is observed between a voltage measurement value of the fuel cell which indicates the actual power generation status of the fuel cell and a voltage estimated value of the fuel cell which indicates the power generation status of the fuel cell estimated with reference to the schedule information, the prediction model correction means corrects the parameter used by the prediction model.

### Configuration 6:

The fuel cell control system according to Configuration 5, wherein the parameter used by the prediction model is a velocity constant.

### REFERENCE SIGNS LIST

2 fuel cell control system
4 fuel cell
6 various types of sensors
10 motive power command unit (PM control model)
11 motive power distribution control unit
12 maximum and minimum setting unit
13 intermittent control unit
20 FC control unit
21 FC state output unit (FC model)
22 correction unit (FC degradation estimation model)
23 endurance distance prediction unit (endurance distance prediction model)
30 PM control parameter correction unit (PM control model)
40 storage unit
221 catalyst surface area estimation and prediction unit
222 velocity constant correction unit

1. A fuel cell control system comprising:
control model execution means for executing a control model for controlling power generation of a fuel cell in accordance with schedule information which indicates use of drive means that is driven using the fuel cell as motive power;
prediction model execution means for executing a prediction model for predicting, from a power generation status of the fuel cell, electric power that can be generated by the fuel cell as a predicted power generation capacity;
prediction model correction means for determining that an error occurs in the predicted power generation capacity predicted using the prediction model when a gap greater than or equal to a predetermined gap is observed between an actual power generation status of the fuel cell and a power generation status of the fuel cell estimated with reference to the schedule information, and for correcting a parameter used in the prediction model so as to remove the error in the predicted power generation capacity; and
control model correction means for correcting a parameter in the control model to enable the fuel cell to achieve a target power generation capacity of the fuel cell obtained from the schedule information when a predicted power generation capacity predicted using the prediction model for which parameter correction has been performed is less than the target power generation capacity.

2. The fuel cell control system according to claim 1, wherein
the drive means is a movable traveling means,
the control model controls the power generation of the fuel cell so that a target distance obtained from the schedule information can be traveled,
the prediction model predicts a driving range of the traveling means as the predicted power generation capacity, and
when the driving range of the traveling means predicted by the prediction model is less than the target distance, the control model correction means corrects the parameter used by the control model to enable the fuel cell to achieve the target power generation capacity so that the traveling means can travel the target distance.

3. The fuel cell control system according to claim 1, wherein the control model correction means performs at least one of either correction toward a decrease in a parameter value that defines a maximum value in the power generation of the fuel cell or correction toward an increase in a parameter value that defines a minimum value in the power generation of the fuel cell.

4. The fuel cell control system according to claim 1, wherein the control model correction means corrects the parameter used by the control model so that the drive means is driven at minimum total cost.

5. The fuel cell control system according to claim 1, wherein, when a gap greater than or equal to a predetermined gap is observed between a voltage measurement value of the fuel cell which indicates the actual power generation status of the fuel cell and a voltage estimated value of the fuel cell which indicates the power generation status of the fuel cell estimated with reference to the schedule information, the prediction model correction means corrects the parameter used by the prediction model.

6. The fuel cell control system according to claim 5, wherein the parameter used by the prediction model is a velocity constant.
